(19) United States
(12) Patent Application Publication
(10) Pub. No.: US 2026/0178945 A1
(43) Pub. Date: Jun. 25, 2026

(54) MACHINE LEARNING EXPLAINABILITY FRAMEWORK FOR MACHINE LEARNING CLASSIFIERS BASED ON LABELED BINARY VECTORS FOR A DATA OBJECT

(71) Applicant: Optum, Inc., Minnetonka, MN (US)

(72) Inventors: Sanjit Singh Batra, Millbrae, CA (US); Robert Elliott Tillman, Long Island City, NY (US)

(21) Appl. No.: 18/986,865

(22) Filed: Dec. 19, 2024

(51) Int. Cl. G06N 5/045; G06N 20/10

(52) U.S. Cl. CPC G06N 5/045; G06N 20/10

(57) ABSTRACT

Various embodiments of the present disclosure provide a machine learning framework for machine learning classifiers based on labeled binary vectors for a data object. The techniques comprise generating a data matrix object based on a group of partially masked sets and a group of training predictions respectively generated by a pre-trained classifier using a group of partially masked sets, training a tabular machine learning model using the data matrix object as a training dataset, determining a set of importance scores that respectively correspond to the set of text segments based on one or more parameters of the tabular machine learning model determined during the training, and providing at least one text segment of the set of text segments to associate with the original prediction as a reason the original prediction was generated.

### BACKGROUND

Traditionally, a classifier model may be applied to text and other data elements to perform a classification prediction task. While typically accurate, such classifier models are prone to feature biases and/or model inefficiencies. Moreover, such classifier models are typically complex machine learning (ML) models (e.g., “black box” models) such that explainability of the classifier models is difficult to achieve. As such, it is desirable to improve explainability, efficiency, and/or reliability of classifier models.

### BRIEF DESCRIPTION OF THE DRAWINGS

FIG. 1 depicts an example overview of an architecture in accordance with some embodiments of the present disclosure.

FIG. 2 depicts an example predictive data analysis computing entity in accordance with some embodiments of the present disclosure.

FIG. 3 depicts an example client computing entity in accordance with some embodiments of the present disclosure.

FIG. 4 depicts a dataflow diagram showing a first portion of an example training data generation stage of a staged explainability framework accordance with some embodiments of the present disclosure.

FIG. 5 depicts a dataflow diagram showing a second portion of an example training data generation stage of a staged explainability framework in accordance with some embodiments of the present disclosure.

FIG. 6 depicts a dataflow diagram showing a third portion of an example training data generation stage of a staged explainability framework in accordance with some embodiments of the present disclosure.

FIG. 7 depicts a dataflow diagram showing example tabular ML model training, importance determination, and explanation stages of a staged explainability framework in accordance with some embodiments of the present disclosure.

FIG. 8 depicts an operational example of an example explanation stage of a staged explainability framework in accordance with some embodiments of the present disclosure.

FIG. 9 depicts an operational example of an explainability pipeline in accordance with some embodiments of the present disclosure.

FIG. 10 depicts an example flow chart diagram of an explainability process in accordance with some embodiments of the present disclosure.

### DETAILED DESCRIPTION

Various embodiments of the present disclosure provide an ML framework that transforms a traditionally feature engineering task for tabular ML models into a ML explainability task for pre-trained classifiers. To do so, the ML framework defines a multi-stage framework, comprising a set of stages to collectively provide improved explainability for a pre-trained classifier. The pre-trained classifier, for example, may have been previously trained to classify input data objects, such as a document, image, and/or the like, into one or more of a set of classes. Pre-trained classifiers may be implemented using complex model architectures that render their predictions (e.g., the one or more classes) unexplainable because they comprise intermediate layers that may not be humanly interpreted. For example, a pre-trained classifier may comprise a deep neural network, transformer-based architecture, and/or the like, that may generate a score (and/or set of scores) to indicate the predicted classification (e.g., based on a maximum score from a set of scores respectively corresponding to a set of classes, a single score between 0 and 1 where a score less than 0.5 identifies a first classification and a score greater than or equal to 0.5 identifies a second classification, a set of scores that respectively correspond to different classes of a multi-classification task) through a series of complex encoding, embedding, attention, and/or activation functions that obscure the influence of particular portions of an input to a resulting score. By way of example, the predictions ultimately output by model architectures, such as neural networks, transformers, and/or the like, may be based on complex activation functions, such as a sigmoid, a weight and bias for that sigmoid, attention mechanisms that project human-readable information into vectors of thousands of dimensions and carry out a specific sequence of dot products and multiplication, and/or the like. Moreover, the number of activation functions and/or discrete attention mechanisms thereof may reach millions and/or billions in some applications, and the data between such layers may be represented as sets of tensors of hundreds and/or thousands of dimensions indicating logit values interpretable to the model but not a human. This complexity, and form of encoding, embedding, attending, and activating sets of tensors between ML layers improves the accuracy of pre-trained classifiers at the cost of the explainability of the resulting output. The reduction of explainability (e.g., an understanding of why and/or how a model makes a prediction) is an unsolved problem in ML that reduces the usability of certain model architectures for various computing use cases.

For example, even if a pre-trained classifier is highly performing in terms of accuracy (and/or various other performance metrics), the obfuscation of the relevant portions of an input that leads to accurate classification may enable undetected biases within the pre-trained classifier, hinder downstream applications by failing to narrow a focus of downstream applications to portions of an original input, among other technical challenges. For instance, pre-trained classifier may be implemented in various computing applications as a filtering tool for filtering, routing, and/or otherwise pre-processing an input for downstream computer processes that may depend on more than just the classification output by the pre-trained classifier. As one example, a pre-trained classifier may comprise a data object classifier that predicts whether a data object (e.g., an image, document) is applicable for operations of a downstream computing task. In such a case, the downstream computing task may process the data object to generate another classification, prediction, and/or the like that may be based on the same and/or a portion of the data used by the pre-trained classifier to generate the classification output. This leads to redundant computing operations due to the lack of explainability of the pre-trained classifier outputs. For example, without a means of explanation, downstream processes for a data object must restart the processing task for a data object using only a classification, rather than portions of a data object that contributed to the classification.

Some embodiments of the present disclosure address explainability challenges of pre-trained classifiers, with low and/or no explainability, by detecting a portion of input data, such as a text segment from a document, a bounding box from an image, and/or the like, that contributed to a predictive output of a pre-trained classifier. By doing so, some embodiment of the present disclosure provided monitoring mechanisms for pre-trained classifiers, while also narrowing the focus of downstream computing tasks by passing contextual data with the predictive outputs of a pre-trained classifier that explain the classifiers outputs.

More particularly, various embodiments of the present disclosure provide a staged ML framework for a pre-trained classifier that comprises a first, training data generation stage, a second, tabular ML model training stage, a third, importance determination stage, and fourth, explanation stage. Through the series of stages, the staged ML framework may train a tabular ML model that is specific to an input data object for a pre-trained classifier for use with explanation of predictions output by the pre-trained classifier with respect to the input data object. As described herein, unlike model architectures for pre-trained classifiers, tabular ML models may be compatible with a variety of feature selection and/or explainability mechanisms for better understanding the influence of individual components of an input data object to an end prediction. The staged ML framework enables an explanation approach for pre-trained classifiers by transforming such mechanisms for use with pre-trained classifiers through a proxy tabular ML model. In this way, the staged ML framework directly address technical challenges with traditional pre-trained classifier that allows the use of pre-trained classifiers in more sophisticated computer processes.

In some embodiments, during a training data generation stage, a system may receive an input data object (e.g., a document, image) and break the input data object input a set of segments (e.g., chunking a document into text segments, dividing an image into bounding boxes). The system may mask different subsets of segments from the set of segments to generate partially masked sets (e.g., up to each with a subset of masked segments and a subset of unmasked segments) from the input data object. The system may use the pre-trained classifier (e.g., referenced above) to generate a prediction (e.g., a classification score output by the model, such as a logit or normalized logit indicating a posterior probability) for up to each of the partially masked sets using the different subsets of unmasked segments therein. The system may generate vector data objects for up to each of the partially masked sets in which a vector data object for a partially masked set may indicate (i) the subset of masked/unmasked segments (e.g., via a binary value, such a “1” indicating masked and/or “0” indicating unmasked) and (ii) the prediction for the partially masked set. This process may be repeated using a different permutations of masking (e.g., where at least one segment is masked/unmasked differently compared to previous masking permutations) until a predefined stop condition is reached, such as a pre-defined number of iterations, a pre-defined minimum number of predictions of a particular type, a convergence heuristic is satisfied, and/or that like, to generate a data matrix object of a set of vector data objects. In this manner, during the training data generation stage, the system may create a data matrix object that may identify relationships between portions of an input data object and a prediction of a pre-trained classifier in tabular format. This, in turn, enables the use of the data matrix object with tabular ML models which, as described herein, may be compatible with explainability mechanisms that are incompatible with the pre-trained classifier.

In some embodiments, during a tabular ML model training stage, the system aggregates a set of vector data object into the data matrix object and uses the data matrix object to train a tabular ML model (e.g., an ML model with an explainable/inspectable structure), such as a decision tree (e.g., a boosted decision tree, such as XGBoost and/or the like), support vector machine (SVM), regression model, and/or the like, using the partially masked sets (e.g., as represented by binary values within the vector data objects) as input and the predictions associated therewith as ground truth data. For example, where the ML model is a decision tree, the leaf nodes may be associated with the prediction space (e.g., the range of possible outputs) of the pre-trained classifier by virtue of using the predictions as training data, and the tree parameters (e.g., split parameters) may be iteratively instantiated and altered such that the observed combinations of unmasked segments that resulted in the different predictions by the pre-trained classifier during the iterative masking process described above reduces a Gini impurity and/or other residual of the tree given a random combination of unmasked segments. In this manner, the system may train a tabular ML model to learn relationships between a pretrained classifier's predictions and the segments of an input data object. This, in turn, allows for analysis (e.g., use of compatible explainability mechanisms) of the structure of the tabular ML model to derive explainable insights for the internal mechanisms of the pre-trained classifier.

In some embodiments, during an importance determination stage, the system uses the resultant tabular ML model's architecture itself to determine an importance score for up to each segment in the set of segments of the input data object. In an example where the tabular ML model trained as described above is a decision tree, the importance score for a segment may be determined by determining a Shapley additive explanations (SHAP) value based on the node splits within the tree, the final leaf node predictions, and/or a path from the root node to a leaf node. For example, a split in the decision tree may be based on a particular segment and/or a probability associated therewith, and the final leaf node may indicate a prediction and/or the likelihood associated therewith. This data may be used to determine something like a SHAP value that may indicate a magnitude of influence the segment has on generating a particular prediction. As described herein, the tabular model architecture of the tabular ML model allows for the use of several different explainability mechanisms for which the SHAP value is just one example. Other examples may comprise local interpretable model-agnostic explanations (LIME), Shapely additive global importance (SAGE), Gini importance scores, partial dependence plots (PDPs), accumulated local effects (ALE) plots, individual conditional expectation (ICE) plots, and/or the like. Moreover, the techniques may additionally or alternatively comprise other feature importance determinations depending on the type of tabular ML model trained by the described techniques. For example, if the ML model is an SVM that uses linear kernels, an importance score may be determined based on the weights assigned to the text segments during training. In this manner, during an importance determination stage, the system may leverage the interpretable structure of a tabular ML model to generate importance scores that indicate an influence of and/or unique interactions between different combinations of segments on particular predictions and/or global influence of one or more segments on the scope of predictions (e.g., the output space) the pre-trained classifier is capable of generating.

In some embodiments, during an explanation stage, the system leverages the importance scores from the tabular ML model (e.g., as provided by its interpretable structure) to determine an influence of the segments of the input data object on a prediction of the pre-trained classifier. For example, the system may generate an explanation output for the pre-trained classifier that identifies one or more segments from the input data object that are associated with importance scores that meet or exceed a threshold (e.g., 0.3, 0.5, 0.7). In addition, or alternatively, the explanation output for the pre-trained classifier may identify a top subset of segments (e.g., top k segments ranked by importance score, where k is a positive integer) from the input data object that are associated with a subset of highest importance scores. In some examples, the explanation output may provide the one or more segments as contextual data. In addition, or alternatively, the explanation output may provide a summary of the one or more segments (e.g., a reason generated by an LLM based on the one or more segments) and/or one or more segment-level indicators (e.g., a numerical value, a categorical tag, such as “No Influence”, “Moderate Influence,” “Likely Reason”, a color gradient reflective of a categorical tag and/or numerical value) that identify an importance score for up to each of segments of the input data object.

In some embodiments, the system applies the staged ML framework for up to each of a set of unique input data objects to generate a separate explainability outputs that are tailored to a particular input to a pre-trained classifier. For instance, a separate tabular ML model may be trained and assessed for up to each of the unique input data objects. In some examples, different model architectures of tabular ML models may be trained based on the input data object. For example, the model architecture may be based on a data type (e.g., audio, image, text), length (long or short text), and/or the like. In some examples, the choice of the model (e.g., a hyperparameter) may be determined using a parameter that may be changed during training. By way of example, a set of different model architectures and/or model types may be assessed, and the parameter may be determined based on the highest performing (e.g., in terms of recall, accuracy) model type. In this way, the staged ML framework enables the adaptable combinations of different model architecture to both predict and then explain machine learning based classifications for various computing tasks. By doing so, the techniques of the present disclosure may improve the performance of machine learning systems in various technology domains, such as cybersecurity, healthcare, manufacturing systems, and/or the like, to improve the predictive capacity (e.g., in terms of accuracy, bias control) of such systems and allow for the detection of influential portions of an inputs. The later of which may enable the discovery of previously undetected correlations in data, which may be used to detect previously undetectable software bugs, diseases, system malfunctions, and/or the like, depending on the particular domain.

### I. OVERVIEW OF EMBODIMENTS

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

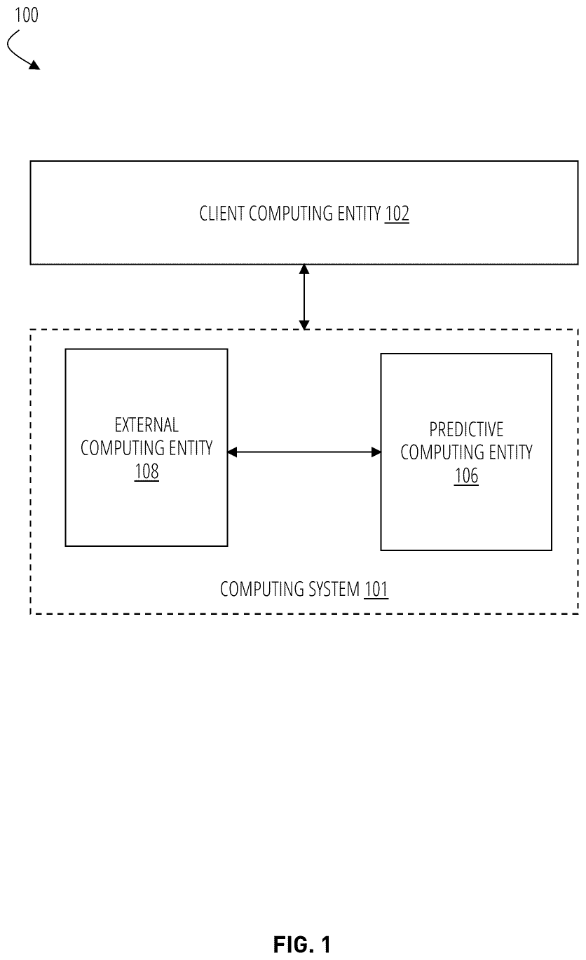

FIG. 1 depicts an example overview of an architecture 100 in accordance with some embodiments of the present disclosure. The architecture 100 comprises a computing system 101 configured to receive a request, such as a user interface request, a computing task request, a machine learning request, a model prompt request, a query, and/or the like, from client computing entities 102, process the request, and provide one or more responses, such as model output, machine learning output, a data visualization, a user interface overlay, one or more graphical elements, and/or the like to the client computing entities 102. The example architecture 100 may be used in a plurality of domains and not limited to any specific application as disclosed herewith. The plurality of domains may comprise healthcare, industrial, manufacturing, computer security, and/or the like to name a few.

In accordance with various embodiments of the present disclosure, one or more machine learned models may be trained to generate candidate outputs, candidate output scores, and/or other machine learned outputs. The models may be adapted to a differential request handling engine and/or complementary scoring mechanism that may collectively process a request using data scaling and/or data pre-processing. Some techniques of the present disclosure may adapt traditional models to a cohesive modeling framework for more efficiently handling portions of the request handling process.

In some embodiments, the computing system 101 communicates with at least one of the client computing entities 102 using one or more communication networks. Examples of communication networks comprise any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate code predictions, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate classifier models in accordance with one or more training and/or inference operations of the present disclosure. In some examples, the external computing entities 108 may be configured to train, implement, use, update, and evaluate classifier models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., request handling, classifier modeling techniques, machine learning explainability techniques, machine learning feature extraction techniques, etc.) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as one or more recorded entity cohorts and/or the like, to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

In some example embodiments, the predictive computing entity 106 may be configured to receive a trained model trained and subsequently provided by the one or more external computing entities 108. For example, the one or more external computing entities 108 may be configured to perform one or more training steps/operations of the present disclosure to train a model, as described herein. In such a case, the trained model may be provided to the predictive computing entity 106, which may leverage the trained model to perform one or more inference steps/operations of the present disclosure. In some examples, feedback (e.g., evaluation data, ground truth data) from the use of the model may be received and/or stored by the predictive computing entity 106. In some examples, the feedback may be provided to the one or more external computing entities 108 to continuously train the model over time. In some examples, the feedback may be leveraged by the predictive computing entity 106 to continuously train the model over time. In this manner, the computing system 101 may perform, via one or more combinations of computing entities, one or more prediction, training, and/or any other modeling techniques of the present disclosure.

### A. Example Predictive Computing Entity

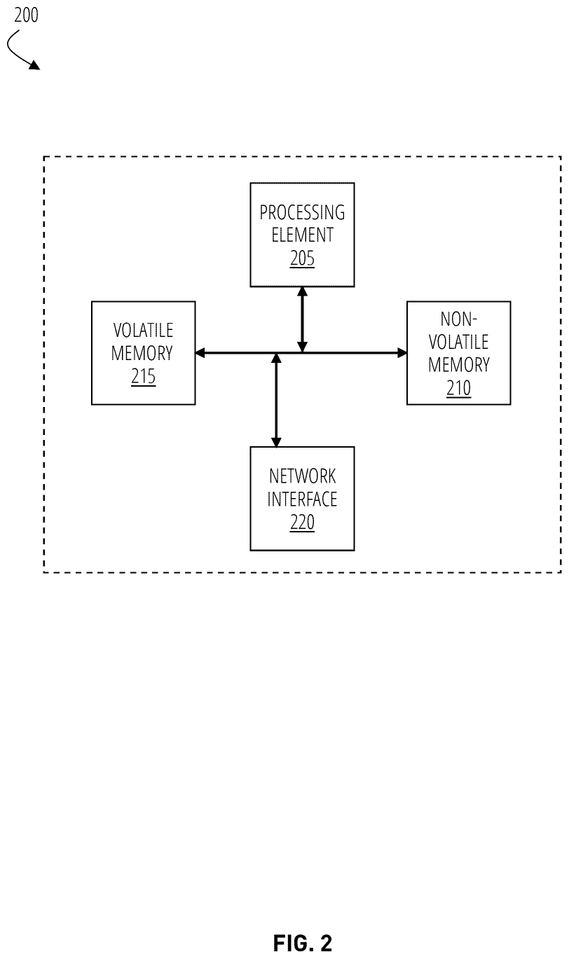

FIG. 2 depicts an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably) and/or volatile memory 215 (also referred to as volatile media, storage, memory storage, memory circuitry, and/or similar terms used herein interchangeably), as discussed above.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium including random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As will be recognized, the non-volatile memory 210 and/or the volatile memory 215 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, including as computer program products that comprise articles of manufacture. Such computer program products may comprise one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (including volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may in addition or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may in addition or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

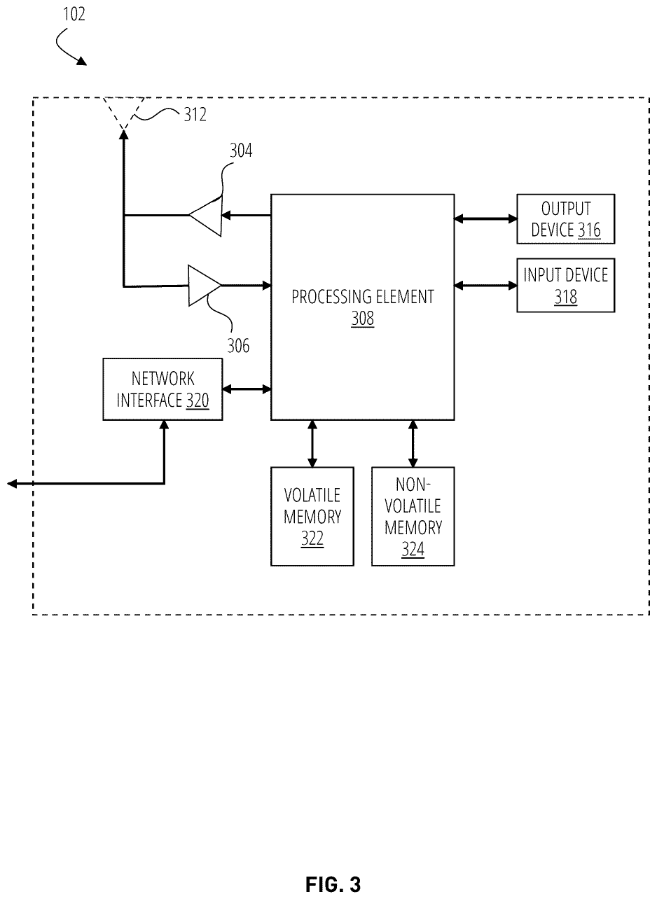

FIG. 3 depicts an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may in addition or alternatively download code, changes, add-ons, and updates, for instance, to its firmware, software (e.g., including executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may in addition or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. EXAMPLE SYSTEM OPERATIONS

As indicated, various embodiments of the present disclosure make important technical contributions to machine learning systems by providing a staged explainability framework for pre-trained classifiers that defines a unique arrangement of different model architectures that transform architecture-specific mechanisms to traditionally incompatible ML models. In this manner, the staged explainability framework provides an automated solution to several technical challenges with traditional, black box ML model architectures that sacrifice interpretability for improved accuracy and speed related to their interpretable counterparts. Ultimately, the staged explainability framework provides explainability improvement to machine learning technology that, when implemented by a computer, improve the functionality of the computer with respect to various domains, include image recognition, bug detection, and/or the like.

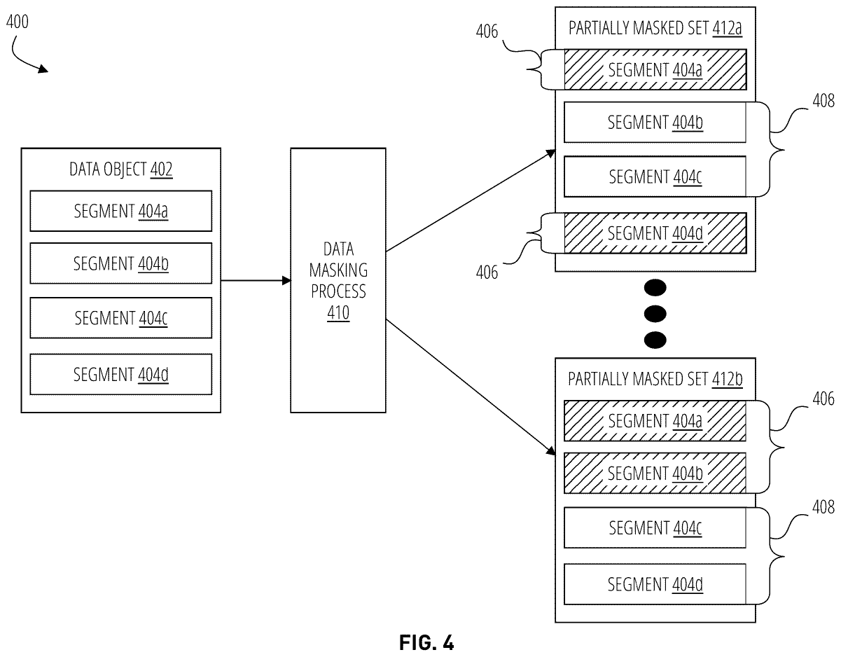

FIG. 4 depicts a dataflow diagram 400 showing a first portion of an example training data generation stage of a staged explainability framework accordance with some embodiments of the present disclosure. In some examples, the first portion of the example training data generation stage may comprise a data masking process 410 that may be iteratively applied to a data object 402 to generate a set of partially masked sets 412a-b from the segments 404a-d of the data object 402. By way of example, the first portion of the example training data generation stage may be implemented by a computing system, such as the computing system 101, to generate set of partially masked sets 412a-b for training a downstream ML model. For instance, up to each of the set of partially masked sets 412a-b may comprise one or more different combinations masked segments 406 and/or unmasked segments 408. In the example depicted, the first partially masked set 412a may comprise a subset of masked segments 406 that mask a first segment 404a and/or a fourth segment 404d of the set of segments 404a-d and/or the second partially masked set 412b may comprise a subset of masked segments 406 that mask the first segment 404a and a second segment 404b of the set of segments 404a-d. In some examples, the first partially masked set 412a may be generated during a first iteration of the data masking process 410 and/or the second partially masked set 412b may be generated during a second iteration of the data masking process 410. In this manner, the computing system 101 may iteratively apply the data masking process 410 to the data object 402 to generate the set of partially masked sets 412a-b. As described herein, the computing system 101 may leverage up to each of the partially masked sets 412a-b as training inputs during one or more training operations of the staged explainability framework.

In some embodiments, the computing system 101 receives a data object 402 for a pre-trained classifier. The data object 402, for example, may comprise a document data object, an image data object, a video data object, and/or other recorded media in any form. For instance, the data object 402 may comprise a data construct reflects unlabeled content that may be leveraged by a pre-trained classifier as features for a prediction. The pre-trained classifier, for example, may process the content within a data object 402 to assign one or more classification labels to the data object 402 based on one or more learned parameters of the pre-trained classifier.

The content within a data object 402 may be expressed in any form. For example, the data object 402 may comprise a structured and/or unstructured (e.g., natural language document) document that comprises a collection of terms, phrases, and/or other textual content associated with a target prediction of a pre-trained classifier. As another example, the data object 402 may comprise an image, video, audio clip, and/or the like that comprises a collection of media content associated with a target prediction of a pre-trained classifier. The target prediction and/or the substance of the content within a data object 402 may be specific to a particular prediction domain. In a clinical domain, for example, the data object 402 may comprise medical notes, clinical notes, medical charts, discharge summaries, and/or the like, that describe, in text, image, audio, and/or the like, a clinical attribute (e.g., International Classification of Diseases (ICD) codes, Current Procedural Terminology (CPT) codes, prescription (RX) codes) for a target entity (e.g., a member). As another example, in a cybersecurity domain, the data object 402 may comprise computer access logs, activity monitor report, and/or the like, that describe, in text, image, audio, and/or the like, a security attribute (e.g., Common Vulnerabilities and Exposures (CVE) codes) for a target entity (e.g., a computer).

In some embodiments, the computing system 101 chunks the data object 402 into a set of segments. For example, the computing system 101 may generate a set of segments from the data object 402 by chunking the content (e.g., in the form of imagery, test, audio) within the data object 402 into fixed sized chunks. In some examples, the computing system may chunk the data object 402 into the set of segments 404a-d based on a set of data chunking rules. The set of data chunking rules, for example, may be associated with a token limit of a pre-trained classifier.

In some embodiments, a segment of the set of segments 404a-d is a data construct that describes a portion of the content within a data object 402. For instance, the portion of content may comprise a sequence of words within a document data object, a bounding box within an image data object, an audio segment of an audio data object, and/or the like. In a text example, a segment may comprise a text segment that comprises a sequence of words represented as a sequence of tokens (e.g., word-level tokens, sub-word tokens). A text segment, for example, may comprise a sentence, text sequence, clinical note line, and/or any other segment of text from a document.

In some embodiments, the computing system 101 generates the set of segments 404a-n from the data object 402 by parsing the data object 402 in accordance with a set of data chunking rules. The set of data chunking rules, for example, may enable formatting and/or sizing of an embedding data structure for a pre-trained classifier in accordance with a type of domain for a classification task associated with the pre-trained classifier. By way of example the set of data chunking rules may comprise a data chunking rule associated with a token limit of the pre-trained classifier. In addition, or alternatively, the set of data chunking rules may comprise a data chunking rule associated with sentence length limit (e.g., for document data objects), bounding box dimensions (e.g., for image data objects), and/or other criteria associated with any other data chunking technique.

In some embodiments, up to each segment of the set of segments 404a-d initially comprise an unmasked portion of the data object 402. The computing system 101 may mask, in accordance with the data masking process 410, at least one of the set of segments 404a-d to generate a permutation of a partially masked set 412, such as the first partially masked set 412 a and/or the second partially masked set 412b shown in FIG. 4.

In some embodiments, the computing system 101 masks a subset of segments of the set of segments 404a-d to determine a partially masked set 412. In some examples, the computing system 101 may iteratively perform the data masking process 410 to generate a set of partially masked sets 412a-b from the data object 402. Up to each partially masked set of the set of partially masked sets 412a-b may be comprise a partially masked version of the data object 402 that, as described herein, may be leverages to understand an influence of different segments on a prediction for the data object 402.

In some embodiments, a partially masked set is one of a set of masked permutations of the set of text segments 404a-d within a data object 402. For instance, the computing system 101 may generate a partially masked set (e.g., a masked permutation of the data object 402) by applying a masking operation (e.g., padding) to one or more of the set of segments 404a-b within the data object 402. The computing system may apply the masking operation at random (e.g., using a random number generator), at a defined pattern (e.g., masking every other text segment starting from a different initial point), and/or using any other selection technique. The number of masked segments 406 and/or unmasked segments 408 may be equal and/or different across up to each of the set of partially masked set 412a-b. In some examples, number of masked segments 406 and/or unmasked segments 408 may be based on a masking threshold (e.g., 2, 20%).

In some examples, at up to each iteration of the data masking process 410, the computing system 101 may generate a masking value that may indicate a subset of masked segments 406 (e.g., via position indices) that may be treated as nonce data (e.g., through padding) for a particular partially masked set. The computing system 101 may generate the partially masked set for the particular iteration by setting the subset of masked segments 406 to a nonce value, removing the subset of masked segments 406 from the partially masked set, and/or the like. In some examples, the computing system 101 may repeat the data masking process 410 for a set of iterations to generate a set of partially masked sets 412a-b that comprise different permutations of masked segments 406 and/or unmasked segment 408.

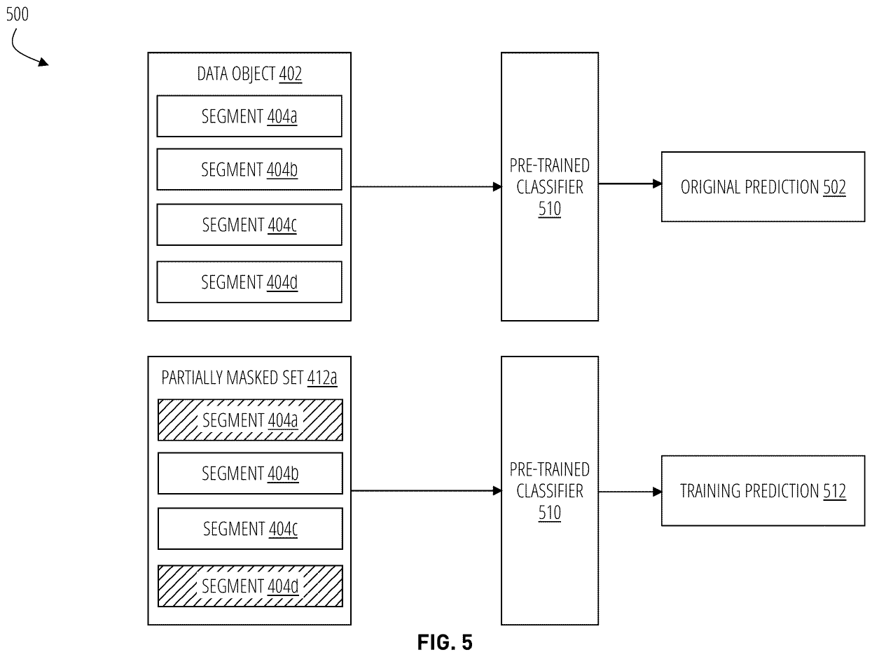

FIG. 5 depicts a dataflow diagram 500 showing a second portion of an example training data generation stage of a staged explainability framework in accordance with some embodiments of the present disclosure. In some examples, the second portion of the example training data generation stage may comprise a classification process that may be iteratively applied to the data object 402 and/or a set of partially masked sets from the data object 402 to generate a set of predictions. For instance, the computing system 101 may apply a pre-trained classifier 510 to the data object 402 to generate an original prediction 502 for the data object 402 based on the set of segments 404a-d. In addition, or alternatively, the computing system 101 may apply the pre-trained classifier 510 to the partially masked set 412a to generate a training prediction 512 for the partially masked set 412a based on the set of unmasked segments 404a and 404d of the partially masked set 412a. Using the pre-trained classifier 510, the computing system 101 may generate a training prediction 512 for up to each of a set of partially masked sets, as described with reference to FIG. 4. As described herein, the computing system 101 may leverage up to each of the training predictions 512 as ground truths for their respective partially masked sets during one or more training operations of the staged explainability framework.

In some embodiments, the computing system 101 generates, using the pre-trained classifier 510 and the data object 402, an original prediction 502 for the data object 402. The original prediction 502, for example, may be based on up to each of the segments 404a-d of the data object 402.

In some embodiments, the pre-trained classifier 510 is an ML classification model that is trained to generate a prediction based on an input data object, such as the data object 402. The ML classification model may comprise any machine learning architecture. In some examples, the machine learning architecture may comprise a black box architecture, such as a neural network, in which correlations between features is uninterpretable to a human. For example, the pre-trained classifier 510 may comprise a set of trained parameters (e.g., coefficient(s), weight(s), biase(s), activation function(s), action function type(s) in examples where the activation function and/or function type is determined as part of training) determined as a result of training the pre-trained classifier 510 based on training hyperparameters and/or structural hyperparameters defining the model's architecture. In some examples, structural hyperparameter(s) may define component(s) of the model's architecture and/or their configuration/order, such as, for example, the configuration/order specifying which output(s) of one component are provided as input to other component(s); a number, type, and/or configuration of component(s) per layer, a number of layers of the model, a number of input nodes in an input layer of the model, a number of output nodes of an output layer of the model, component dimension (e.g., input size versus output size), and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., embedding model(s), generative pre-trained transformer(s) (GPT(s))), neural network(s), multi-layer perceptron(s), and/or the like.

In some embodiments, the pre-trained classifier 510 comprises a supervised, semi-supervised, and/or unsupervised model that is trained using a training dataset. For instance, the supervised and/or semi-supervised model may be trained using one or more supervised and/or semi-supervised training techniques (e.g., backpropagation of errors using gradient descent) based on a labeled training dataset that comprises a set of ground truths (e.g., values, classifications, probability scores) for a set of training entries. The set of ground truths may comprise single classifications (e.g., for binary classification models) and/or multiple classifications (e.g., for multi-classification models). Tor instance, the pre-trained classifier 510 may comprise a binary classification ML model, a multi-classification ML model, and/or any other ML variation. The pre-trained classifier 510 may be trained by optimizing a loss function, such as binary cross entropy, and/or the like. In some examples, the loss function may be modified to enable multiple classifications. For instance, for a multi-class ML model, the pre-trained classifier 510 may be trained using a softmax cross entropy loss, sparse cross entropy loss, Kullback-Leibler Divergence loss, and/or the like.

In some embodiments, the computing system 101 generates, using the pre-trained classifier and/or the partially masked set 412a, a training prediction 512. The training prediction 512, for example, may be based on the unmasked segments 404b-c of the partially masked set 412a. In some examples, the original prediction 502 may comprise a first classification score for the data object 402 and/or the training prediction 512 may comprise a second classification score for the data object 402 that is different than the first classification score. In this manner, the training prediction 512 may be predictive of an influence of the masked segments 404a and 404d of the partially masked set 412a on an original prediction 502 (e.g., based on a difference between the original prediction 502 and/or the training prediction 512).

In some embodiments, the prediction of the pre-trained classifier 510 comprises a classification output that comprises one or more values and/or classes associated with a data object 402. For example, the prediction may comprise at least one classification score (e.g., probability, ratio, value between 0 and 1) that is generated by the pre-trained classifier 510 using the data object 402 (and/or a masked permutation thereof) as input. The pre-trained classifier 510 may be configured to generate a classification score for one (e.g., in a binary classification process) and/or a set (e.g., in a multi-label classification process) of classes. A class may depend on a prediction domain. For instance, in a clinical use case, a class may correspond to a particular medical code, such as a CPT code, ICD, and/or the like. As another example, the class may correspond to a CVE code in a cyber security domain.

In some examples, a class may be determined based on a particular classification score and/or one or more classification thresholds (e.g., 0.5) for the pre-trained classifier. For example, in a binary classification process with two classes (e.g., a negative and positive class), a classification score that is >=0.5 and <=1.0 may be associated with a first class label (e.g., a positive class) and/or a classification score that is <0.5 and >=0.0 may be associated with a second class label (e.g., a negative class). As another example, in a multi-label classification process, the pre-trained classifier 510 may comprise multiple heads, up to each of which may be configured to output a classification score of a different class label. In such a case, one of more class labels associated with a highest classification score may be associated with the input. In some examples, a prediction, such as the original prediction 502 and/or training prediction 512, may comprise a classification score and/or a corresponding class label in a binary use case. In a multi-label use case, the prediction(s) may comprise a set of classification scores and/or one or more class labels associated with a top subset of the set of classification scores.

In addition, or alternatively, the training prediction 512 may comprise a comparison between a classification score of the original prediction and a classification score generated for a partially masked set 412a. By way of example, the training prediction 512 may comprise a difference between (i) the original classification score provided by the pre-trained classifier 510 when no segments are masked and/or (ii) a training classification score provided by the pre-trained classifier 510 when one or more text segments are masked.

In some embodiments, the computing system 101 generates a training prediction for up to each of the partially masked sets in the set of partially masked sets. For instance, the computing system 101 may input up to each of the partially masked sets to the pre-trained classifier 510 to receive a separate training prediction for up to each of the partially masked sets. By doing so, the computing system 101 may generate a set of training predictions that respectively correspond to a plurality of different masked permutation of the data object 402.

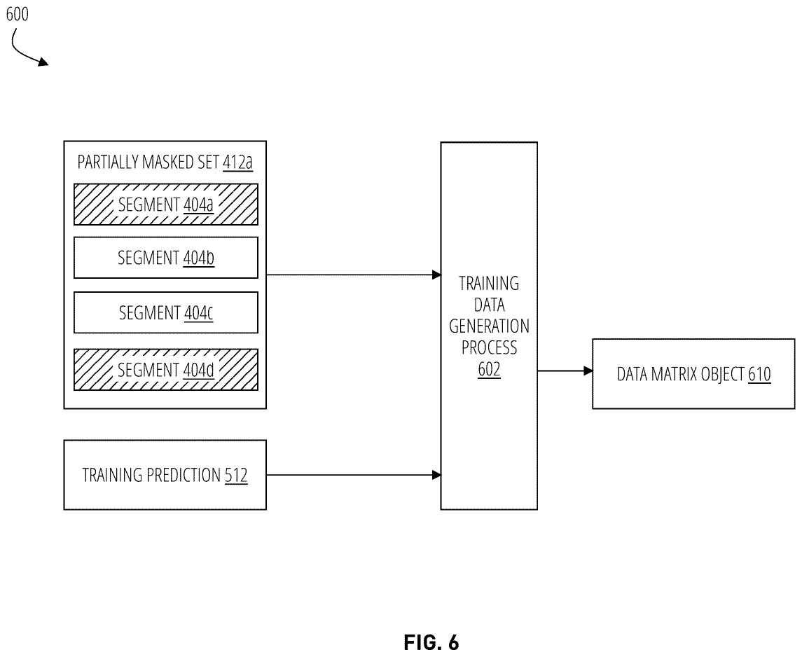

FIG. 6 depicts a dataflow diagram 600 showing a third portion of an example training data generation stage of a staged explainability framework in accordance with some embodiments of the present disclosure. In some examples, the third portion of the example training data generation stage may comprise the training data generation process 602 in which the computing system 101 may store a set of partially masked sets (e.g., as represented by the first partially masked set 412a) and/or a corresponding set of training predictions 512 within a data matrix object 610. For example, the computing system 101 may generate a vector data object for up to each of the set of partially masked sets. A vector data object, for example, may comprise a vectorized representation of the subset of masked segments 404a and 404d, the subset of unmasked segments 404b-c, and/or the training prediction 512 for the partially masked set 412a. In some examples, the computing system 101 may store a vector data object for up to each of a set of partially masked sets within a data matrix object 610 to generate a matrix in which a first dimension (e.g., a row) corresponds to a particular vector data object and a second dimension (e.g., column) corresponds to a segment and/or a training prediction for the data object. As described herein, the computing system 101 may leverage the data matrix object 610 as a tabular training data structure during one or more training operations of the staged explainability framework.

In some embodiments, the computing system 101 generates the data matrix object 610 based on a group of partially masked sets and/or a group of training predictions respectively generated by the pre-trained classifier using the group of partially masked sets, as described with reference to FIG. 5. The data matrix object 610, for example, may comprise a vector data object for up to each of the group of partially masked sets. A vector data object for a particular partially masked set 412a may identify (i) the subset of segments that were masked (e.g., segments 404a and 404d) for the partially masked set 412a and/or (ii) the training prediction 512. In some examples, the vector data object may comprise (i) a binary vector comprising a binary value that identifies a masked status (e.g., 0 for unmasked, 1 for masked) of a segment within the partially masked set 412a and/or (ii) a label for the partially masked set 412a that identifies the training prediction 512. By way of example, the vector data object for the partially masked set 412a may comprise a binary vector that identifies the first segment 404a and the fourth segment 404d as masked (e.g., using a “1”) and the second segment 404b and the third segment 404c as unmasked (e.g., using a “0”). In addition, or alternatively, the vector data object may comprise one or more classification scores, class labels, and/or derivatives thereof of a training prediction 512 generated by the pre-trained classifier based on the partially masked set 412a.

In some embodiments, during the training data generation process 602, the computing system 101 determines a group of masked permutations (e.g., partially masked sets) from the data object, generates a training prediction for up to each of the group of permutations, and stores the permutations and/or the training predictions as vector data objects within a single data structure, the data matrix object 610, that may be used as a training dataset for a tabular ML model. The resulting data matrix object 610, for example, may comprise a multi-dimensional design matrix that comprises a set of rows (e.g., reflective of a particular partially masked set) and/or columns (e.g., reflective of a segment and/or prediction). For example, the data matrix object 610 may comprise a set of binary vectors that respectively indicate different masking permutations of the data object and/or training predictions respectively corresponding to the different masking permutations. In some examples, the data matrix object 610 may comprise a set of indices (e.g., column index) that respectively correspond to the set of segments 404a-d of the data object. In this way, the data matrix object 610 may reduce complex datasets, such as text, images, audio, and/or the like, as represented by a data object into a numerical matrix that may allow for faster training operations for downstream models while retaining a capability of being mapped back to the segments 404a-d of the data object.

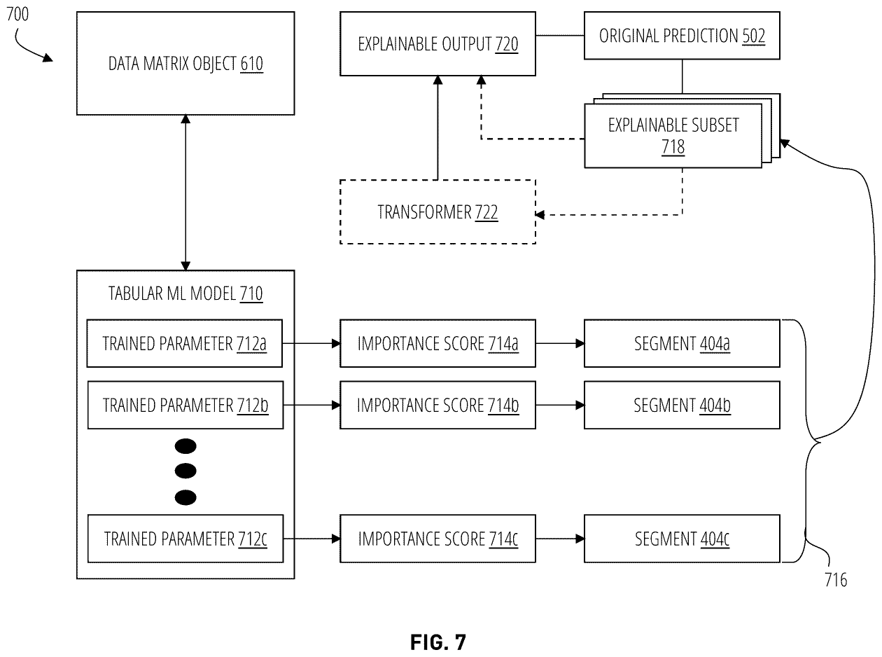

FIG. 7 depicts a dataflow diagram 700 showing example tabular ML model training, importance determination, and explanation stages of a staged explainability framework in accordance with some embodiments of the present disclosure. As depicted, the tabular ML model training, importance determination, and/or explanation stages of a staged explainability framework may leverage the data matrix object 610, through a series of operations, to generate an explainable output 720 for an original prediction 502 of a pre-trained classifier. To do so, during a tabular ML model training stage, the computing system 101 may train a tabular ML model 710 using the data matrix object 610. During the importance determination stage, the computing system 101 may generate a set of importance scores 714a-c based on a set of trained parameters 712a-c of the trained tabular ML model 710. In some examples, up to each of the set of importance scores 714a-c may be mapped to a set of segments 404a-c of the data object, such that the computing system 101 may apply a feature selection mechanism 716 to determine an explainable subset 718 of segments from the set of segments 404a-c. In some examples, during the explanation stage, the computing system 101 may determine the explainable subset 718 and generate an explainable output 720 for the original prediction 502 based on the explainable subset 718. In this manner, the staged explainability framework of the present disclosure may transform feature selection techniques 716 that are compatible with a tabular ML model 710 into a model explanation technique for pre-trained classifiers.

In some embodiments, the computing system 101 trains, using the data matrix object 610 as a training dataset, a tabular ML model 710. In some examples, the tabular ML model 710 may be specific to a particular data object. For instance, a different tabular ML model 710 may be identified, trained, and/or otherwise used for up to each of a set of different data objects. For example, the data object may comprise a first data object of a set of data objects. The tabular ML model 710 may be trained for the first data object, and a second tabular ML model may be trained for a second data object of the set of data objects.

In some embodiments, the tabular ML model 710 comprises an ML architecture that is different than the pre-trained classifier. The ML architecture, for example, may comprise an explainable architecture, such as a decision tree/decision tree forest (e.g., XGBoost), support vector machine (SVM), regression model, and/or the like, that is compatible with one or more feature selection techniques 716 and/or explainability mechanisms that are incompatible with the pre-trained classifier. In this manner, the computing system 101 may use the trained tabular ML model 710 as a proxy for pre-trained classifier to improve the explainability of the pre-trained classifier. The tabular ML model 710, for example, may comprise a set of trained parameters 712a-c, such as weights, biases, split parameters, split functions, and/or the like, that may be leveraged by one or more explainability mechanisms to determine importance scores 714a-c that may be attributable to one or more segments 404a-c of the data object.

In some embodiments, the tabular ML model 710 is identified for a data object from a set of tabular ML models. In some examples, tabular ML model 710 may be identified based on an output type of a pre-trained classifier. For instance, a tabular ML model 710 may comprise a decision tree, SVM, and/or regression model for a binary classification output but only a decision tree and/or SVM for a multi-label classification output. In this way, a set of tabular ML models may be filtered to identify a tabular ML model 710 tailored for a particular data object and/or classification scenario.

In some embodiments, the computing system 101 determines tabular ML model from the set of tabular machine learning models based on a performance of the model after training of the data matrix object 610. For instance, the type of tabular ML model may be determined based on a hyperparameter that may be set and/or reset during training of one or more tabular ML models from the set. For example, the computing system 101 may train, using the data matrix object 610 as the training dataset, a first tabular machine learning model and/or a second tabular machine learning model. The computing system 101 may determine a first performance metric (e.g., accuracy, recall) for the first tabular machine learning model and/or a second performance metric for the second tabular machine learning model and determine the tabular ML model 710 based on the first performance metric and the second performance metric. In this manner, the computing system 101 may iterate through a set of tabular ML models to identify a model that best fits (e.g., in terms of accuracy, recall) a particular data object and/or prediction associated therewith.

In some embodiments, the computing system 101 trains the tabular ML model 710 based on a type of tabular ML model identified for the data object. For instance, the computing system 101 may train the tabular ML model 710, using the data matrix object 610, by inputting a binary vector portion of a vector data object as a training input to the tabular ML model 710 to produce a training output that may be compared, using a selected loss function, to the prediction portion of the vector data object to determine a model loss. In this manner, up to each vector data object (e.g., row) of the data matrix object 610 may be used as a training entry for the tabular ML model 710 to train the tabular ML model 710 to learn correlations between ground truth predictions and different masking permutations of the data object. The learned correlations, for example, may be represented by trained parameters 712a-c that respectively correspond to up to each of the set of segments of the data object.

In some embodiments, the computing system 101 trains the tabular ML model 710 via a training process associated with one or more training stages based on the data matrix object 610 to provide a trained version of the tabular ML model 710 that is uniquely configured for the type of tabular ML model identified for the data object.

In some embodiments, training the tabular ML model 710 may comprise training a boosted decision tree associated with the tabular ML model 710. In some embodiments, training a boosted decision tree may comprise an iterative training process that builds an ensemble of decision trees to create a predictive model. In some embodiments, each iteration may include calculating a difference (e.g., residuals) between target values and predictions of a current decision tree, which may represent errors the current model has not captured. In some embodiments, the calculation may utilize metrics such as Gini impurity or other decision-tree measurements for a classification task. A new decision tree may then be fit to these residuals to enable reduction of the residuals. In some embodiments, the fitting process may include optimizing various portions of a decision tree such as node splits and/or determining whether to instantiate new node splits for the decision tree.

In some embodiments, the new decision tree may be incorporated into the tabular ML model 710, either by replacing an existing decision tree with the new decision tree or adding the decision tree to an ensemble of decision trees. In some embodiments, a contribution of the new decision tree may be scaled by a weight factor. In some embodiments, the weight factor may be adjustable during the fitting process to control the influence of each decision tree in the ensemble. In some embodiments, the fitting process may be repeated for a predetermined number of iterations or until performance of the tabular ML model 710 satisfies performance criteria associated with a validation dataset. For example, the fitting process may be repeated until performance of the tabular ML model 710 reaches a convergence criterion and/or satisfies a predefined convergence heuristic. As such, through iterative refinement, predictive accuracy of the tabular ML model 710 and/or one or more decision trees associated with the tabular ML model 710 may be incrementally improved by addressing errors identified in previous iterations.

The tabular ML model 710 may be a hardware and/or software architecture having one or more parameters and/or coefficients that defined the architecture of the tabular ML model 710. In some embodiments, the one or more parameters and/or coefficients of the tabular ML model 710 are determined and/or tuned during training the tabular ML model 710. In some examples, structural parameter(s) may define component(s) of the model's architecture and/or their configuration/order, such as, for example, the configuration/order specifying which output(s) of one component are provided as input to other component(s); a number, type, and/or configuration of component(s) per layer, a number of layers of the model, a type of estimation technique for the model, and/or the like. In some embodiments, the tabular ML model 710 is a machine learned regression model. In some embodiments, the tabular ML model 710 is configured to utilize one or more modeling techniques, such as linear regression, lasso regression modeling, ridge regression modeling, non-linear regression modeling, stepwise regression modeling, hierarchical linear modeling, mixed-effects modeling, etc. In some embodiments, the tabular ML model 710 is trained using one or more training techniques related to maximum likelihood estimation, Bayesian inferences, etc. Once trained, the tabular ML model 710 may be utilized to interpret explainability associated with the pre-trained classifier 510 and/or the original prediction 502 provided by the pre-trained classifier 510.

In some embodiments, the computing system 101 determines, based on one or more of the trained parameters 712a-c of the tabular ML model 710 determined during the training, a set of importance scores 714a-c that respectively correspond to the set of segments 404a-c of the data object. The set of importance scores 714a-c, for example, may comprise an importance score associated with a segment from the set of segments 404a-c that identifies a magnitude of influence of the segment on the original prediction 502 by the pre-trained classifier.

In some embodiments, the computing system 101 applies one or more importance scoring techniques to the parameters of the trained tabular ML model 710 to generate the set of important scores 714a-c. For example, the computing system 101 may map the parameters of the trained tabular ML model 710 that result from the training to local, combined, and/or global importance scores for up to each segment of the set of text segments 404a-c. For instance, the importance scores 714a-c may comprise SHAP values, LIME scores, and/or normalized model weights (e.g., a normalization of the model's weights, coefficients), and/or the like, that may be determined using one or more explainability mechanisms that are compatible with tabular ML models, such as LIME, SAGE, PDPs, ALE plots, ICE plots, and/or the like. In some examples, the magnitude of an importance scores may indicate an extent of influence (e.g., extent to which a segment affects the original prediction 502 relative to the rest of the segments) a segment has on the pre-trained classifier generating the original prediction 502. In this way, the set of importance scores 714a-c may be used as contextual data to transform an unexplainable output from a black box pre-trained classifier to an interpretable output.

In some examples, the importance scores 714a-c may be based on the type of the tabular ML model 710. For instance, depending on the type of model trained (e.g., if a decision tree or SVM is used), a combination of importance scores 714a-c may be determined, such as by using SHAP, LIME, partial dependence plots, and/or the like. In addition, or alternatively, (e.g., if a regression model is used) the normalized importance scores may be determined, such as by normalizing coefficients of the tabular ML model 710. In either case, a magnitude of an importance score, and/or a combination thereof, may comprise an individual importance scores that defines an extent of influence that a segment has on an original prediction and/or a global importance score that defines an extent of influence that a segment has on all predictions from the pre-trained classifier. The magnitude may comprise a relative magnitude that describes the influence of one segment relative to the set of segments 404a-c. By doing so, the importance scores 714a-c may identify individual segments from the set of segments 404a-c that have a highest relative impact on the original prediction 502 and/or all predictions output by the pre-trained classifier.

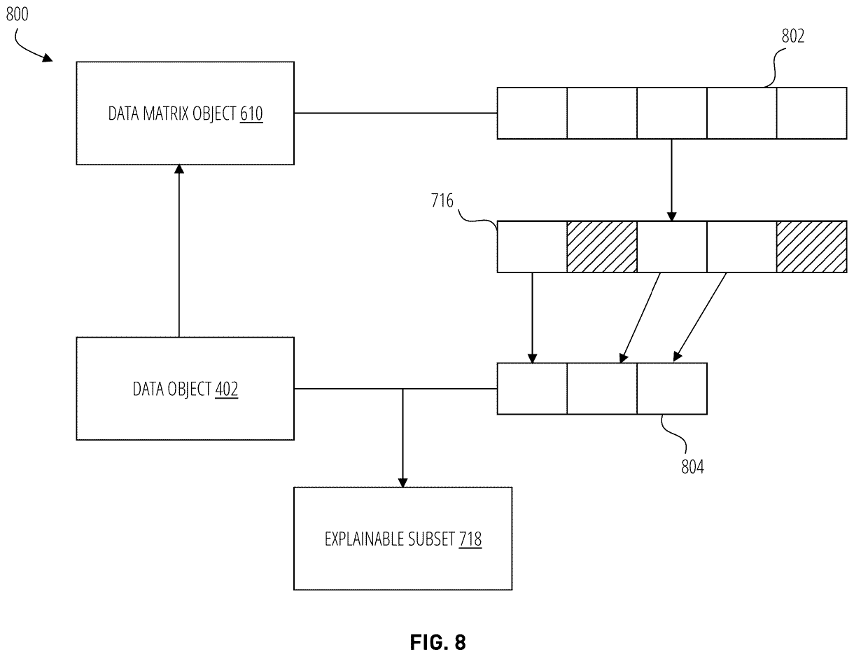

In some embodiments, the computing system 101 provides at least one segment of the set of text segments to associate with the original prediction 502 as a reason the original prediction 502 was generated. For example, the computing system 101 may determine an explainable subset 718 that comprises at least one segment from the set of segments 404a-c. In some examples, the explainable subset 718 may be determined using a feature selection technique 716. The feature selection technique 716, for example, may select one or more highest scoring segments (and/or combinations of segments) from the set of segments 404a-c based on the importance scores 714a-c. For instance, the feature selection technique 716 may define selection criteria, such as a segment threshold (e.g., top k highest scoring segments and/or segment combinations, where k is a real number), a score threshold (e.g., up to each segment associated with an importance score that meets or exceeds a threshold, such as 0.3, 0.5), and/or the like. In some examples, the computing system 101 may apply a feature selection technique 416 to the set of importance scores 714a-c to determine the explainable subset 718 from the set of segments 404a-c. An example feature selection technique 716 may be described in further detail with respect to FIG. 8.

In some embodiments, the computing system 101 generates an explainable output 720 for the pre-trained classifier based on the set of importance scores 714a-c. The explainable output 720, for example, may comprise the original prediction 502 and/or the at least one segment (e.g., an explainable subset 718). For instance, the explainable output 720 may comprise the original prediction 502 and/or an explainable subset 718 of the segments 404a-c as explainable context for the original prediction 502.

The explainable output 920 may comprise data to enable explanation, interpretability, and/or understanding as to why the pre-trained classifier 510 provides the original prediction 502. For example, the explainable output 920 may comprise data that enable identification of important features and/or feature biases for the original prediction 502 provided by the pre-trained classifier 510.

In some embodiments, the explainable output 720 comprises a reason summary for the original prediction 502. The computing system 101, for example, may generate, using a transformer 722, the reason summary based on the explainable subset 718 and generate the explainable output based on the reason summary. By way of example, the computing system 101 may integrate the explainable subset 718 into a prompt template for a transformer, such as a generative pretrained transformer (GPT), and/or the like. The computing system 101 may provide (e.g., through an API call to an internal service, an external service) the resulting prompt to the transformer 722 to generate a reason summary for the original prediction 502 based on the explainable subset 718. The reason summary, for example, may comprise a summarization of the explainable subset 718, and/or the like.

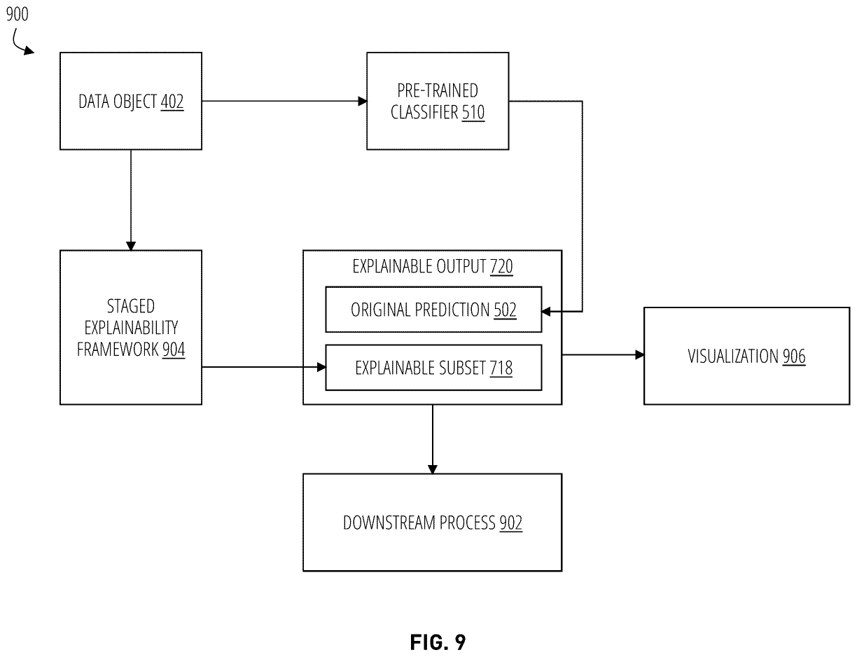

FIG. 9 depicts an operational example 900 of an example explanation stage of a staged explainability framework in accordance with some embodiments of the present disclosure. As depicted, the example explanation stage of the staged explainability framework may apply feature selection techniques 716 that are compatible with a tabular ML model to generate an explainable subset 718 for a data object 402. To do so, the computing system 101 may generate a data matrix object 610 that comprises a set of vector data objects. Up to each of the set of vector data objects may arrange a set of values (e.g., a binary masked/unmasked value) along a common index 802 that comprises an index value (e.g., a column identifier) for up to each of a set of segments of the data object 402.

By applying the staged explainability framework of the present disclosure, the computing system 101 may generate an importance score for up to each index of the common index 802 to generate a set of importance scores indexed based on the placement of corresponding segments within the data object 402. By doing so, a tabular ML model may be trained using a binarized data object (e.g., the data matrix object 610) that replaces the complex data types, such as the text, image, and/or audio data, of the data object 402 with indexed values. The computing system 101 may apply a feature selection technique 716 to the common index 802 to remove one or more indices within the common index 802 that fail to meet and/or exceed feature selection criteria. By way of example, the computing system 101 may remove one or more indices that are outside of a top k number of scores, fail to meet or exceed a score threshold, and/or the like.

In some examples, the remaining (e.g., unpruned) indices 804 may be cross-referenced with the data object 402 to determine the explainable subset 718. The explainable subset 718, for example, may comprise a subset of segments that respectively correspond to the remaining indices 804 that may be down selected by the feature selection technique 716. FIG. 9 depicts an operational example 900 of an explainability pipeline in accordance with some embodiments of the present disclosure. As depicted, the explainability pipeline may be implemented by a computing system, such as the computing system 101 of the present disclosure, to generate an explainable output 720 for an original prediction 502 of a pre-trained classifier 510 with respect to a data object 402. The explainable output 720 may comprise the original prediction 502, an explainable subset 718 for the original prediction 502, and/or a derivative of the explainable subset 718, as described herein. The explainable subset 718 may be generated, using the staged explainability framework, to generate a contextual data for an original prediction 502 of a traditionally black box pre-trained classifier 510.

In some embodiments, the computing system 101 may initiate prediction-based actions and/or visualization 906 based on the explainable output 720. For example, the computing system 101 may provide the explainable output to a downstream process 902 to initiate an action. In addition, or alternatively, the explanation output 720 may provide a summary of one or more segments and/or one or more segment-level indicators (e.g., a numerical value, a categorical tag, such as “No Influence”, “Moderate Influence,” “Likely Reason”, a color gradient reflective of a categorical tag and/or numerical value, etc.) that identify an importance score for up to each of segments of the data object 402.

In some embodiments, a prediction-based action may comprise automated user interface actions, automated alerts, and/or automated adjustments to allocations of computing resources to enable optimized display of the visualization 906. A prediction-based action may further comprise displaying visual renderings, charts, and representations associated with the explainable output 720 via a user interface. In some embodiments, a user interface may be provided via the output device 316 of the client computing entity 102. In some embodiments, a user interface is an electronic interface that provides a display and/or a visualization to a user via a user computing device. In some embodiments, a user interface provides a GUI and/or associated GUI wizard (e.g., executable code configured to control a functionality of GUI) that provides one or more interactive interface screens, representations, and/or widgets for interacting with a user. A user interface may be specially configured to reduce the time, burden, and processing resources traditionally expended to ingest data associated with the explainable output 720. To do so, a user interface may arrange an interactive representation relative to an optimal configuration of representations and/or corresponding interactive widgets. The interactive representation and/or the one or more interactive widgets may be arranged to accommodate small screen sizes, such as mobile devices, laptops, etc., without reducing the efficacy of a reviewing process. This, in turn, allows the performance of traditionally complex data matching operations from a client device with small form factors.

In some embodiments, a user interface may be configured to provide, for display to a user, a visualization associated with the explainable output 720. In some embodiments, a visualization is configured to render one or more graphical elements associated with the explainable output 720. A graphical element may be a formatted version of the explainable output 720 to provide a visualization and/or human interpretation of data via the user interface 1300. In some embodiments, a graphical element is formatted for transmission via a network, an API, a communication channel, a communication interface, the like, or combinations thereof. In one or more embodiments, a graphical element comprises one or more graphical elements and/or one or more textual elements that may be selectable and/or otherwise interacted with via a user interface.

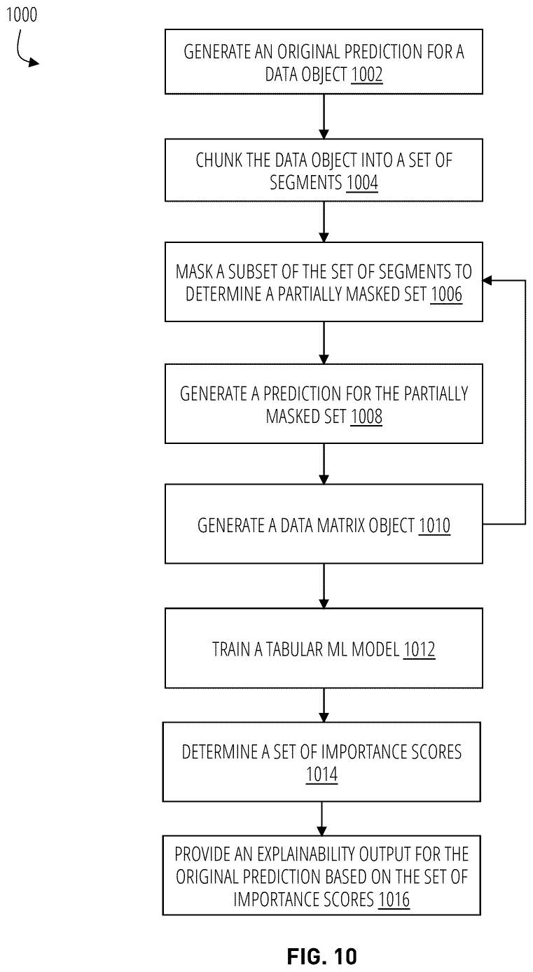

FIG. 10 depicts an example flow chart diagram of an explainability process in accordance with some embodiments of the present disclosure. The process 1000 may be executed by one or more computing devices, entities, and/or systems (e.g., the computing system 101 and/or the predictive computing entity 106) described herein. For example, via the various steps/operations of the process 1000, the computing system 101 may leverage improved data pre-processing, modeling, feature selection, and/or explainability techniques to transform explainability and feature selection techniques traditionally only compatible with tabular ML models into an explainability mechanism for a pre-trained classifier model. By doing so, the process 1000 enables improved machine learning actions related to a defined machine learning task, while ensuring data quality and/or optimized computing resources in view of various data processing and/or modeling rules.

FIG. 10 illustrates an example process 1000 for explanatory purposes. Although the example process 1000 depicts a particular sequence of steps/operations, the sequence may be altered without departing from the scope of the present disclosure. For example, some of the steps/operations depicted may be performed in parallel or in a different sequence that does not materially impact the function of the process 1000. In other examples, different components of an example device or system that implements the process 1000 may perform functions at substantially the same time or in a specific sequence.

In some embodiments, the process 1000 comprises, at step/operation 1002, generating an original prediction for a data object. For example, the computing system 101 may generate, using a pre-trained classifier and a document data object, an original prediction. In some embodiments, the process 1000 comprises, at step/operation 1004, chunking the data object into a set of segments. For example, the computing system 101 may chunk the document data object into a set of text segments. In some examples, chunking the document data object into a set of text segments is based on a set of data chunking rules that is associated with a token limit of the pre-trained classifier.

In some embodiments, the process 1000 comprises, at step/operation 1006, masking a subset of the set of segments to determine a partially masked set. For example, the computing system 101 may mask a subset of text segments of the set of text segments to determine a partially masked set.

In some embodiments, the process 1000 comprises, at step/operation 1008, generating a prediction for the partially masked set. For example, the computing system 101 may generate, using the pre-trained classifier and the partially masked set, a training prediction. In some examples, the original prediction may comprise a first classification score for the document data object and/or the training prediction may comprise a second classification score for the document data object.

In some embodiments, the process 1000 comprises, at step/operation 1010, generating a data matrix. For example, the computing system 101 may generate a data matrix object based on a group of partially masked sets and a group of training predictions respectively generated by the pre-trained classifier using the group of partially masked sets. The data matrix object, for example, may comprise a vector data object that identifies (i) the subset of text segments that were masked for the partially masked set and (ii) the training prediction. The vector data object may comprise (i) a binary vector comprising a binary value that identifies a masked status of the text segment within the partially masked set and/or (ii) a label for the partially masked set that identifies the training prediction.

In some examples, the process 1000 may return to step/operation 1006 to generate another permutation of the partially masked set until a stopping condition is reached. The stopping condition, for example, may comprise a threshold number (e.g., 10, 100, 1000) of partially masked sets, a threshold data matrix size, a threshold number of iterations, and/or the like.

In some embodiments, the process 1000 comprises, at step/operation 1012, training a tabular ML model. For example, the computing system 101 may train, using the data matrix object as a training dataset, a tabular machine learning model. In some examples, the document data object may comprise a first document data object of a set of document data objects, the tabular machine learning model may be trained for the first document data object, and a second tabular machine learning model may be trained for a second document data object of the set of document data objects.

In some examples, the computing system 101 may determine the tabular machine learning model from a set of tabular machine learning models by training, using the data matrix object as the training dataset, a first tabular machine learning model and a second tabular machine learning model, determining a first performance metric for the first tabular machine learning model and a second performance metric for the second tabular machine learning model, and/or determining the tabular machine learning model from the set of tabular machine learning models based on the first performance metric and the second performance metric. In some examples, the pre-trained classifier may comprise a neural network, and the set of tabular machine learning models may (i) comprise one or more decision trees, support vector machines, and/or regression models and/or (ii) may be based on an output type of the pre-trained classifier.

In some embodiments, the process 1000 comprises, at step/operation 1014, determining a set of important scores. For example, the computing system 101 may determine, based on one or more parameters of the tabular machine learning model determined during the training, a set of importance scores that respectively correspond to the set of text segments. The set of importance scores may comprise an importance score associated with a text segment from the set of text segments that identifies a magnitude of influence of the text segment on the original prediction by the pre-trained classifier.

In some embodiments, the process 1000 comprises, at step/operation 1016, providing an explainability output for the original prediction based on the set of importance scores. For example, the computing system 101 may provide at least one text segment of the set of text segments to associate with the original prediction as a reason the original prediction was generated. In some examples, the computing system 101 may apply a feature selection technique to the set of importance scores to determine an explainable subset from the set of text segments. The computing system 101 may provide the at least one text segment based on the explainable subset.

In some examples, the computing system may generate an explainable output for the pre-trained classifier based on the set of importance scores. The explainable output may comprise the original prediction and/or the at least one text segment. In some examples, the explainable output may comprise a reason summary for the original prediction. The computing system 101 may generate the explainable output generating, using a transformer, the reason summary based on the at least one text segment and generating the explainable output based on the reason summary.

Some techniques of the present disclosure enable the generation of action outputs that may be performed to initiate one or more real world actions to achieve real-world effects. In some embodiments, the machine learning and/or explainability techniques of the present disclosure may be used, applied, and/or otherwise leveraged to augment a user interface, which may help in the creation and provisioning of messages across computing entities, as well as other downstream tasks such as rendering of a visualization via a user interface. For instance, explainable output, using some of the techniques of the present disclosure, may trigger the performance of actions at a client device, such as the display, transmission, and/or the like of data reflective of a visualization. In some embodiments, the visualization may trigger an alert via a user interface.

In some examples, the explainable output may cause actions based on a defined domain task and/or a particular computing task. A defined domain task and/or a particular computing task may comprise any environment in which computing systems may be applied to generate a visualization and initiate the performance of computing tasks responsive to a visualization. These actions may cause real-world changes, for example, by controlling a hardware component of a user device or a server device, providing alerts, interactive actions, and/or the like. For instance, actions may comprise the initiation of automated instructions across and between devices, automated notifications, automated data processing actions, and/or the like. In some embodiments, an action (e.g., a prediction-based action) comprises real-time configuration of a user interface based on the explainable output to enable a user to consume visual data associated with the explainable output in an interactive manner, where the visual data is tailored based on the explainable output.

### IV. CONCLUSION

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components may provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and may operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations may be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and may be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” may be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations may encompass implementations in which performance of the operations is divided among the processor(s) in any suitable way. For example, “generating, by one or more processors, X; and generating, by the one or more processors, Y” may encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters(e.g., for unsupervised machine-learned models).

In some examples, structural hyperparameter(s) may define component(s) of the model's architecture and/or their configuration/order, such as the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### V. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may comprise a single computing entity that is configured to perform all of the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising: generating, by one or more processors and using a pre-trained classifier and a document data object, an original prediction; chunking, by the one or more processors, the document data object into a set of text segments; masking, by the one or more processors, a subset of text segments of the set of text segments to determine a partially masked set; generating, by the one or more processors and using the pre-trained classifier and the partially masked set, a training prediction; generating, by the one or more processors, a data matrix object based on a group of partially masked sets and a group of training predictions respectively generated by the pre-trained classifier using the group of partially masked sets, wherein the data matrix object comprises a vector data object that identifies (i) the subset of text segments that were masked for the partially masked set and (ii) the training prediction; training, by the one or more processors and using the data matrix object as a training dataset, a tabular machine learning model; determining, by the one or more processors and based on one or more parameters of the tabular machine learning model determined during the training, a set of importance scores that respectively correspond to the set of text segments, the set of importance scores comprising an importance score associated with a text segment from the set of text segments that identifies a magnitude of influence of the text segment on the original prediction by the pre-trained classifier; and providing, by the one or more processors, at least one text segment of the set of text segments to associate with the original prediction as a reason the original prediction was generated.

Example 2. The computer-implemented method of example 1, wherein the document data object is a first document data object of a set of document data objects, the tabular machine learning model is trained for the first document data object, and a second tabular machine learning model is trained for a second document data object of the set of document data objects.

Example 3. The computer-implemented method of any of the above examples, wherein the vector data object comprises (i) a binary vector comprising a binary value that identifies a masked status of the text segment within the partially masked set and (ii) a label for the partially masked set that identifies the training prediction.

Example 4. The computer-implemented method of any of the above examples, wherein the original prediction comprises a first classification score for the document data object and the training prediction comprises a second classification score for the document data object.

Example 5. The computer-implemented method of any of the above examples, wherein chunking the document data object into the set of text segments is based on a set of data chunking rules that is associated with a token limit of the pre-trained classifier.

Example 6. The computer-implemented method of any of the above examples, further comprising: determining the tabular machine learning model from a set of tabular machine learning models by: training, using the data matrix object as the training dataset, a first tabular machine learning model and a second tabular machine learning model; determining a first performance metric for the first tabular machine learning model and a second performance metric for the second tabular machine learning model; and determining the tabular machine learning model from the set of tabular machine learning models based on the first performance metric and the second performance metric.

Example 7. The computer-implemented method of any of the above examples, wherein the set of tabular machine learning models (i) comprises one or more decision trees, support vector machines, or regression models and (ii) is based on an output type of the pre-trained classifier.

Example 8. The computer-implemented method of any of the above examples, wherein providing the at least one text segment comprises generating an explainable output for the pre-trained classifier based on the set of importance scores, wherein the explainable output comprises the original prediction and the at least one text segment.

Example 9. The computer-implemented method of any of the above examples, wherein the explainable output comprises a reason summary for the original prediction and the generating the explainable output comprises: generating, using a transformer, the reason summary based on the at least one text segment; and generating the explainable output based on the reason summary.

Example 10. The computer-implemented method of any of the above examples, wherein providing the at least one text segment comprises: applying a feature selection technique to the set of importance scores to determine an explainable subset from the set of text segments; and providing the at least one text segment based on the explainable subset.

Example 11. A system comprising: one or more processors; and one or more memories storing processor-executable instructions that, when executed by the one or more processors, cause the one or more processors to perform operations comprising: generating, by a pre-trained classifier and using a data object, an original prediction; masking a subset of a set of segments to determine a partially masked set; generating, using the pre-trained classifier and the partially masked set, a training prediction; generating a data matrix object based on a group of partially masked sets and a group of training predictions respectively generated by the pre-trained classifier using the group of partially masked sets, wherein the data matrix object comprises a vector data object that identifies (i) the subset of segments that were masked for the partially masked set and (ii) the training prediction; training, using the data matrix object as a training dataset, a tabular machine learning model; determining, based on one or more parameters of the tabular machine learning model determined during the training, a set of importance scores that respectively correspond to the set of segments, the set of importance scores comprising an importance score associated with a segment from the set of segments that identifies a magnitude of influence of the segment on the original prediction by the pre-trained classifier; and providing at least one segment of the set of segments to associate with the original prediction as a reason the original prediction was generated.

Example 12. The system of example 11, wherein the data object is a first data object of a set of data objects, the tabular machine learning model is trained for the first data object, and a second tabular machine learning model is trained for a second data object of the set of data objects.

Example 13. The system of any of the above examples, wherein the vector data object comprises (i) a binary vector comprising a binary value that identifies a masked status of the segment within the partially masked set and (ii) a label for the partially masked set that identifies the training prediction.

Example 14. The system of any of the above examples, wherein the original prediction comprises a first classification score for the data object and the training prediction comprise a second classification score for the data object.

Example 15. The system of any of the above examples, wherein chunking the data object into a set of segments is based on a set of data chunking rules that is associated with a token limit of the pre-trained classifier.

Example 16. The system of any of the above examples, wherein the operations further comprise: determining the tabular machine learning model from a set of tabular machine learning models by: training, using the data matrix object as the training dataset, a first tabular machine learning model and a second tabular machine learning model; determining a first performance metric for the first tabular machine learning model and a second performance metric for the second tabular machine learning model; and determining the tabular machine learning model from the set of tabular machine learning models based on the first performance metric and the second performance metric.

Example 17. The system of any of the above examples, wherein the pre-trained classifier is a neural network, and the set of tabular machine learning models (i) comprises one or more decision trees, support vector machines, or regression models and (ii) is based on an output type of the pre-trained classifier.

Example 18. One or more non-transitory computer-readable media storing processor-executable instructions that, when executed by one or more processors, cause the one or more processors to perform operations comprising: generating, by a pre-trained classifier and using a data object, an original prediction; masking a first subset of a set of segments to determine a partially masked set; generating, using the pre-trained classifier and the partially masked set, a training prediction; generating a data matrix object based on a group of partially masked sets and a group of training predictions respectively generated by the pre-trained classifier using the group of partially masked sets, wherein the data matrix object comprises a vector data object that identifies (i) the subset of segments that were masked for the partially masked set and (ii) the training prediction; training, using the data matrix object as a training dataset, a tabular machine learning model; determining, based on one or more parameters of the tabular machine learning model determined during the training, a set of importance scores that respectively correspond to the set of segments, the set of importance scores comprising an importance score associated with a segment from the set of segments that identifies a magnitude of influence of the segment on the original prediction by the pre-trained classifier; and providing at least one segment of the set of segments to associate with the original prediction as a reason the original prediction was generated.

Example 19. The one or more non-transitory computer-readable media of example 18, wherein providing the at least one segment comprises generating an explainable output for the pre-trained classifier based on the set of importance scores, wherein the explainable output comprises the original prediction and the at least one segment.

Example 20. The one or more non-transitory computer-readable media of any of the above examples, wherein the explainable output comprises a reason summary for the original prediction and the generating the explainable output comprises: generating, using a transformer, the reason summary based on the at least one segment; and generating the explainable output based on the reason summary.

Example 21. The computer-implemented method of example 1, wherein the method further comprises training the pre-trained classifier.

Example 22. The computer-implemented method of example 21, wherein the training is performed by the one or more processors.

Example 23. The computer-implemented method of example 21, wherein the one or more processors are comprised in a first computing entity; and the training is performed by one or more other processors comprised in a second computing entity.

Example 24. The computing system of example 11, wherein the one or more processors are further configured to train the pre-trained classifier.

Example 25. The computing system of example 24, wherein the one or more processors are comprised in a first computing entity; and the pre-trained classifier is trained by one or more other processors comprised in a second computing entity.

Example 26. The one or more non-transitory computer-readable storage media of example 18, wherein the instructions further cause the one or more processors to train the pre-trained classifier.

Example 27. The one or more non-transitory computer-readable storage media of example 26, wherein the one or more processors are comprised in a first computing entity; and the pre-trained classifier is trained by one or more other processors comprised in a second computing entity.

Example 28. The computer-implemented method of example 1, wherein the training the tabular machine learning model is performed by the one or more processors.

Example 29. The computer-implemented method of example 28, wherein the one or more processors are comprised in a first computing entity; and the training is performed by one or more other processors comprised in a second computing entity.

Example 30. The computing system of example 11, wherein the one or more processors are comprised in a first computing entity; and the tabular machine learning model is trained by one or more other processors comprised in a second computing entity.

Example 31. The one or more non-transitory computer-readable storage media of example 18, wherein the one or more processors are comprised in a first computing entity; and the tabular machine learning model is trained by one or more other processors comprised in a second computing entity.

1. A computer-implemented method comprising:
generating, by one or more processors and using a pre-trained classifier and a document data object, an original prediction;
chunking, by the one or more processors, the document data object into a set of text segments;
masking, by the one or more processors, a subset of text segments of the set of text segments to determine a partially masked set;
generating, by the one or more processors and using the pre-trained classifier and the partially masked set, a training prediction;
generating, by the one or more processors, a data matrix object based on a group of partially masked sets and a group of training predictions respectively generated by the pre-trained classifier using the group of partially masked sets, wherein the data matrix object comprises a vector data object that identifies (i) the subset of text segments that were masked for the partially masked set and (ii) the training prediction;
training, by the one or more processors and using the data matrix object as a training dataset, a tabular machine learning model;
determining, by the one or more processors and based on one or more parameters of the tabular machine learning model determined during the training, a set of importance scores that respectively correspond to the set of text segments, the set of importance scores comprising an importance score associated with a text segment from the set of text segments that identifies a magnitude of influence of the text segment on the original prediction by the pre-trained classifier; and
providing, by the one or more processors, at least one text segment of the set of text segments to associate with the original prediction as a reason the original prediction was generated.

2. The computer-implemented method of claim 1, wherein the document data object is a first document data object of a set of document data objects, the tabular machine learning model is trained for the first document data object, and a second tabular machine learning model is trained for a second document data object of the set of document data objects.

3. The computer-implemented method of claim 1, wherein the vector data object comprises (i) a binary vector comprising a binary value that identifies a masked status of the text segment within the partially masked set and (ii) a label for the partially masked set that identifies the training prediction.

4. The computer-implemented method of claim 1, wherein the original prediction comprises a first classification score for the document data object and the training prediction comprises a second classification score for the document data object.

5. The computer-implemented method of claim 1, wherein chunking the document data object into the set of text segments is based on a set of data chunking rules that is associated with a token limit of the pre-trained classifier.

6. The computer-implemented method of claim 1, further comprising:
determining the tabular machine learning model from a set of tabular machine learning models by:
training, using the data matrix object as the training dataset, a first tabular machine learning model and a second tabular machine learning model;
determining a first performance metric for the first tabular machine learning model and a second performance metric for the second tabular machine learning model; and
determining the tabular machine learning model from the set of tabular machine learning models based on the first performance metric and the second performance metric.

7. The computer-implemented method of claim 6, wherein the set of tabular machine learning models (i) comprises one or more decision trees, support vector machines, or regression models and (ii) is based on an output type of the pre-trained classifier.

8. The computer-implemented method of claim 1, wherein providing the at least one text segment comprises generating an explainable output for the pre-trained classifier based on the set of importance scores, wherein the explainable output comprises the original prediction and the at least one text segment.

9. The computer-implemented method of claim 8, wherein the explainable output comprises a reason summary for the original prediction and the generating the explainable output comprises:
generating, using a transformer, the reason summary based on the at least one text segment; and
generating the explainable output based on the reason summary.

10. The computer-implemented method of claim 8, wherein providing the at least one text segment comprises:
applying a feature selection technique to the set of importance scores to determine an explainable subset from the set of text segments; and
providing the at least one text segment based on the explainable subset.

11. A system comprising:
one or more processors; and
one or more memories storing processor-executable instructions that, when executed by the one or more processors, cause the one or more processors to perform operations comprising:
generating, by a pre-trained classifier and using a data object, an original prediction;
masking a subset of a set of segments to determine a partially masked set;
generating, using the pre-trained classifier and the partially masked set, a training prediction;
generating a data matrix object based on a group of partially masked sets and a group of training predictions respectively generated by the pre-trained classifier using the group of partially masked sets, wherein the data matrix object comprises a vector data object that identifies (i) the subset of segments that were masked for the partially masked set and (ii) the training prediction;
training, using the data matrix object as a training dataset, a tabular machine learning model;
determining, based on one or more parameters of the tabular machine learning model determined during the training, a set of importance scores that respectively correspond to the set of segments, the set of importance scores comprising an importance score associated with a segment from the set of segments that identifies a magnitude of influence of the segment on the original prediction by the pre-trained classifier; and
providing at least one segment of the set of segments to associate with the original prediction as a reason the original prediction was generated.

12. The system of claim 11, wherein the data object is a first data object of a set of data objects, the tabular machine learning model is trained for the first data object, and a second tabular machine learning model is trained for a second data object of the set of data objects.

13. The system of claim 11, wherein the vector data object comprises (i) a binary vector comprising a binary value that identifies a masked status of the segment within the partially masked set and (ii) a label for the partially masked set that identifies the training prediction.

14. The system of claim 11, wherein the original prediction comprises a first classification score for the data object and the training prediction comprise a second classification score for the data object.

15. The system of claim 11, wherein chunking the data object into a set of segments is based on a set of data chunking rules that is associated with a token limit of the pre-trained classifier.

16. The system of claim 11, wherein the operations further comprise:
determining the tabular machine learning model from a set of tabular machine learning models by:
training, using the data matrix object as the training dataset, a first tabular machine learning model and a second tabular machine learning model;
determining a first performance metric for the first tabular machine learning model and a second performance metric for the second tabular machine learning model; and
determining the tabular machine learning model from the set of tabular machine learning models based on the first performance metric and the second performance metric.

17. The system of claim 16, wherein the pre-trained classifier is a neural network, and the set of tabular machine learning models (i) comprises one or more decision trees, support vector machines, or regression models and (ii) is based on an output type of the pre-trained classifier.

18. One or more non-transitory computer-readable media storing processor-executable instructions that, when executed by one or more processors, cause the one or more processors to perform operations comprising:
generating, by a pre-trained classifier and using a data object, an original prediction;
masking a first subset of a set of segments to determine a partially masked set;
generating, using the pre-trained classifier and the partially masked set, a training prediction;
generating a data matrix object based on a group of partially masked sets and a group of training predictions respectively generated by the pre-trained classifier using the group of partially masked sets, wherein the data matrix object comprises a vector data object that identifies (i) the subset of segments that were masked for the partially masked set and (ii) the training prediction;
training, using the data matrix object as a training dataset, a tabular machine learning model;
determining, based on one or more parameters of the tabular machine learning model determined during the training, a set of importance scores that respectively correspond to the set of segments, the set of importance scores comprising an importance score associated with a segment from the set of segments that identifies a magnitude of influence of the segment on the original prediction by the pre-trained classifier; and
providing at least one segment of the set of segments to associate with the original prediction as a reason the original prediction was generated.

19. The one or more non-transitory computer-readable media of claim 18, wherein providing the at least one segment comprises generating an explainable output for the pre-trained classifier based on the set of importance scores, wherein the explainable output comprises the original prediction and the at least one segment.

20. The one or more non-transitory computer-readable media of claim 19, wherein the explainable output comprises a reason summary for the original prediction and the generating the explainable output comprises:
generating, using a transformer, the reason summary based on the at least one segment; and
generating the explainable output based on the reason summary.
